(19) United States
(12) Patent Application Publication
(10) Pub. No.: US 2009/0138500 A1
(43) Pub. Date: May 28, 2009

(54) METHOD OF COMPACT DISPLAY COMBINED WITH PROPERTY-TABLE-VIEW FOR A COMPLEX RELATIONAL DATA STRUCTURE

(76) Inventors: Zhiqiang YUAN, Sunnyvale, CA (US); Jang Fung Chen, Cupertino, CA (US); Sangbong Park, Union City, CA (US)

Correspondence Address: PILLSBURY WINTHROP SHAW PITTMAN, LLP, P.O. BOX 10500, MCLEAN, VA, 22102, US

(21) Appl. No.: 12/248,833

(22) Filed: Oct. 9, 2008

Related U.S. Application Data
(60) Provisional application No. 60/960,757, filed on Oct. 12, 2007.

(51) Int. Cl. G06F 17/30

(52) U.S. Cl. 707/103 R; 707/E17.045

(57) ABSTRACT

A method of managing data with a relational data structure, wherein the data having one or more tree structures having sub-tree structures, each tree or sub-tree structure comprising nodes, and relationship information indicating a relationship between the nodes, comprises allocating at least one of the tree structures or the sub-tree structures into another tree structure according to the relationship information, if the relationship information indicates that a node in the at least one of the tree structures or the sub-tree structures relates to one or more of the nodes of the another tree structure.

### CROSS-REFERENCE TO RELATED APPLICATIONS

The present application claims priority from U.S. Prov. Appln. No. 60/960,757, filed Oct. 12, 2007, the contents of which are incorporated herein by reference in their entirety.

### FIELD OF THE INVENTION

The present invention relates generally to methods for displaying information. More specifically, this invention provides methods and systems for displaying data having a complex relational data structures, such as a tree based data structure or a relational table based flat data structure, in simplified format.

### BACKGROUND OF THE INVENTION

Prior to discussing the background associated with the present invention, nomenclature utilized throughout this application is defined. In this application “Node” means any object and its properties under a data structure which can be described as a node on a graphical representation. “Relationship” means any link between two nodes, which can be one-directional or bi-directional “Parent/Child/Sibling” means that if a path directly connects from A to By then”—A is the parent, and B is the child and if B and C share the same parent, they are siblings. “Descendant/Ancestor” means that if a path exists from A to B, then A is the ancestor and B is the descendant. “Dependency Relationship” means that if a change of node A can result in a change in node B, there is a dependency of B upon A. “Cross Dependency” means a dependency of B upon A if B is not a descendant of A. “Root” means a node that does not have parent. “Leaf” means a node that does not have any child. “Depth” means the number of nodes on the path from the root to a node. “Level” means the displaying depth of the node and Nodes that have same depth are usually on the same level. “Reference Relationship” means a leaf node that represents a non-leaf node. “Property” means the description of data field. “Property value” means the value of certain data field. “Property and-and-value index” means a unique identifier of each individual element. “Property View” means an enhancement of the tree-view where each node has two items, the property name and the property value. “Combined Property/Table View” means a combination of the property view and table view. Property view provides a hierarchical view of the node and Table view correspondingly provides an overall view of that node.

Most computer applications require displaying of representations of linked information such as hierarchical data having a tree structure or a relational table based flat data structure. The linked information refers to information that has some logical or organizational relationship, which may be one-directional or bi-directional. For examples, organization charts, computer programs, filing systems, or simulation systems include such hierarchical data structure. Usually, these data structures are often too large to be displayed within the screen of a computer display monitor. Thus, it has been necessary to provide ways of displaying these structures for users to easily find elements in the structure and to understand the relationship among/between elements.

FIG. 1 shows a conventional relational data structure presented in a graphical fashion. In FIG. 1, each object contains several properties and/or some related object. For example, the Object 1 (1) contains Properties 1, 2 and 3 and Related Objects 2 and 3. The Object 2 (2) contains Properties 4 and 5 and Related Objects 4 and 5. The data structure further includes Relationship table 3 which contains Relationships 1-4 in a table format. For example, the Relationship 1 represents the relationship between the Object 1 and 2. In FIG. 1, the data structure is represented in a flat structural view, but not in a hierarchical view. It is noted that when the number of objects increases, the relationship table becomes increasingly more complicated.

FIG. 2 also shows another conventional data structure presented in a tree graph. In FIG. 2, there are three tree structures: the first tree structure 4 under the root node A, the second tree structure 5 under the root node F and the third tree structure 6 under the root node C. For example, the first tree structure 4 contains three properties, one object N and two relationships 41 and 42 under the node A. The object N contains two objects D and G, one property and one relationship L. The objects D and 6 each contain three properties, respectively, and one of the properties under the object G contains another property K. These three tree structures may be independent trees or they may be sub-trees under another parent node.

The reference node 41 contains the reference relationship to the object 51 under the node F, the reference node 42 represents the reference relationship to the root node F and reference node 44 represents the reference relationship to the objects H, I and J under the node C. Further, the reference nodes 61-63 may represent the reference relationships to another system 7. The data structure shown in FIG. 2 further contains the relationship table 8 including the reference relationship between the node D and E, for example. The General Relationship can be represented as either a dependency relationship or a reference relationship. In the given case, the DIE is a reference relationship, but they can not be represented on the graph since the relationship can not be represented on the traditional tree graph.

The tree graph shown in FIG. 2 may also be represented by a table view. FIG. 3 shows a conventional table view of the tree 4 shown in FIG. 2. In the table view 9, the property values p1, p2 and p3 included in the object D and the property values p1′, p2′ and p3′ included in the object G are displayed. It is noted that the value of the node K is not displayed.

These conventional representations of the data structure shown in FIGS. 1-3, however, have the following problems. First, there is no efficient way to search a node. For example, in FIG. 2, since the multiple tree entries, which have to be a root of the tree, corresponding to A, F, and C are necessary for different purposes of navigation, there is no one-through-all solution. If the users want to navigate from the node A to B, they have to go through the entry A first, navigate to L, get the reference to J, and then go through another entry C that contains J, and eventually get to the node B. As a result, when navigating from the node A to By the users have to go through the node C, redundant information will be generated when navigating throughout the tree.

Second, referencing for a non-leaf node is not allowed since the non-leaf node already contains children, thus it can not establish a link to other non-leaf nodes. For example, in FIG. 2, when the users navigate from the node A to E, if the node D has a relationship with the node E, the navigation has to go through the node A to get the object D and access the relationship table 8 to get the relationship D/E, and then proceed to the tree 5 to get the object E through the node F. But, since D is a non-leaf node, it cannot have a link to E. A non-leaf node already has some children therefore it is not an empty node. Traditional tree reference representation is with empty nodes since only empty nodes (leaf nodes) don't have any other meanings.

Third, there is no effective way to update cross dependent nodes because updating the cross dependency must be performed on part of the tree or all over the tree. For example, in FIG. 2, if the property B depends on the property K, a dependency relationship has to be used to define that dependency, but a change of the property K can not be directly sent to the node B. In most cases, existing dependency relationship doesn't specify the receiving object, where the dependency existed. In order to update the dependent object, all the objects including dependent and non-dependent of the same class will need to be updated. This is resulting in redundant updating. Tree H,I,J are based on same class, so they have the same architecture, therefore not only B of tree J will be updated, the same element as B of J inside tree H,I will also be updated.

Fourth, there is redundancy of information and display. When navigating through the tree structure, in order to locate a node, it is mandatory to go through all the higher level nodes. Their siblings and all of the objects (may or may not be of the same class) within the tree structure must be retrieved or displayed. These results in redundant sibling node retrieval or display for each hierarchical level. For example, in FIG. 2, the nodes D and G are in the same class and the nodes H, I and J are same class, which are all represented as sibling nodes in the graph. Thus, when displaying the node D, for example, the node G must be retrieved and displayed.

Fifth, changing the display is inflexible. To display different depth nodes on same level or to manage distributed nodes among different classes with similar properties is not possible. Since the nodes are generally residing at their fixed locations, the user can not change the display level of the nodes.

Moreover, only the limited information is displayed with an inflexible table view. Since the table view has only one-level information for the given node, it cannot display all of the descendant node information if the descendant node is not one of the direct child-nodes, nor can it display the referenced object properties. It can only define one-level of children of the current node, thus no non-child descendants or referenced object node properties can be allowed for the table view. For example, in FIG. 3, the node K is not allowed in the existing table view 9. If p2 and p2′ are referencing object nodes, the properties of the referenced objects are not allowed in the current table. Since the current implemented table has limited ability to display only its direct children and reference object are enabled as a out-of-tree relationship, therefore in the current table implementation, it cannot see the referenced object's property from the table implementation.

In addition, the overall view of the nodes for the table graph is not possible. Instead, one has to go through numerous tables to get the correct information. If the data tree has multiple objects of the node A, it is not possible to arrange all the A's properties into one table view with existing implementation.

Therefore, it is desirable to provide methods for displaying data having complex relational data structures in flexible formats which overcome the aforementioned problems.

### SUMMARY OF THE INVENTION

It is one objective of the present invention to provide a straightforward upfront indexing method and system using object referencing with a combined property-and-value indexing for a compact system viewer. It is also another objective to provide a simplified data management method and system with the capability of managing descendents and re-organizing descendents by their logic meaning, in which a new combined property-and-value indexing scheme is used for each node.

Yet another objective of the present invention is to provide a simplified table management method and system that is managed by a combined property-and-value indexing system that enables an overall view of selected descendents belonging to the node. It is one objective to provide a simplified method and system to add arbitrary nodes in a hierarchical fashion which enables logical grouping of the nodes but the new node does not have any representation of the background data system. Further, it is one objective of the present invention to provide a simplified cross dependency management system that enables any necessary change made in one node to be easily propagated to the related nodes.

Accordingly, the present invention relates to a method of managing data with a complex relational data structure, wherein the data having one or more tree structures having sub-tree structures, each tree or sub-tree structure comprising nodes, and relationship information indicating a relationship between the nodes, comprises allocating at least one of the tree structures or the sub-tree structures into another tree structure according to the relationship, information, if the relationship information indicates that a node in the at least one of the tree structures or the sub-tree structures relates to one or more of the nodes of the another tree structure.

The method further comprising reallocating a sub-tree structure within a tree structure to which the sub-tree structure belongs. In this method, the reallocating may include adding a node between the sub-tree structure and the tree structure.

In the method of the present invention, the allocating may include adding a value switch between the one of the tree structures or the sub-tree structures and the another tree structure. The method of the present invention may further comprise adding cross dependency information to a node indicating dependency between the nodes. The method of the present invention, wherein the nodes comprise property and value, may further comprise creating a table view displaying the property and value of the nodes.

The present invention also relates to a system for managing data with a relational data structure, wherein the data having one or more tree structures having sub-tree structures, each tree or sub-tree structure comprising nodes, and relationship information indicating a relationship between the nodes, which may comprise a database for storing the relational data structure, and an allocating section configured to allocate at least one of the tree structures or the sub-tree structures into another tree structure according to the relationship information, if the relationship information indicates that a node in the at least one of the tree structures or the sub-tree structures relates to one or more of the nodes of the another tree structure.

Among other advantages as noted below, the method or system of the present invention provides easy navigation through the nodes. It also provides referencing for a non-leaf node. Yet another advantage is that it provides easy and efficient updating of cross dependency among the nodes. It further operates to reduce redundancy and to improved flexibility. The present invention provides an improved table view with respect to overall view and flexibility.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a conventional relational data structure presented in a graphical fashion.

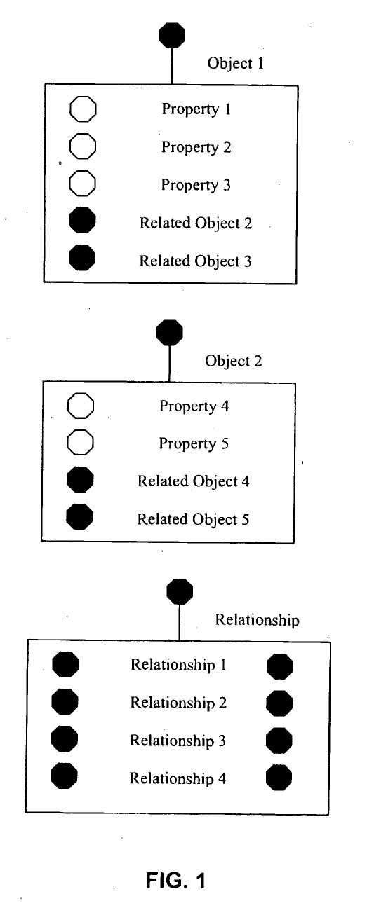

FIG. 2 shows another conventional data structure presented in a tree graph.

FIG. 3 shows a conventional table view.

FIG. 4 shows an exemplary system view in accordance with the present invention.

FIG. 5 shows an exemplary flow chart for monitoring cross-dependency in accordance with the present invention.

FIG. 6 shows exemplary table views of the given embodiment according to the present invention.

FIG. 7 shows an exemplary flow chart in an index analysis system.

FIG. 8 shows an exemplary total flow chart for implementing the method in accordance with the present invention.

FIG. 9 shows application of the present invention to the lithography simulation system.

FIG. 10 shows application of the present invention to the lithography simulation system (a table view).

FIG. 11 shows application of the present invention to the portable device display.

FIG. 12 shows application of the present invention to the portable device display (a table view).

FIG. 13 shows application of the present invention to the portable device display (a table view).

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

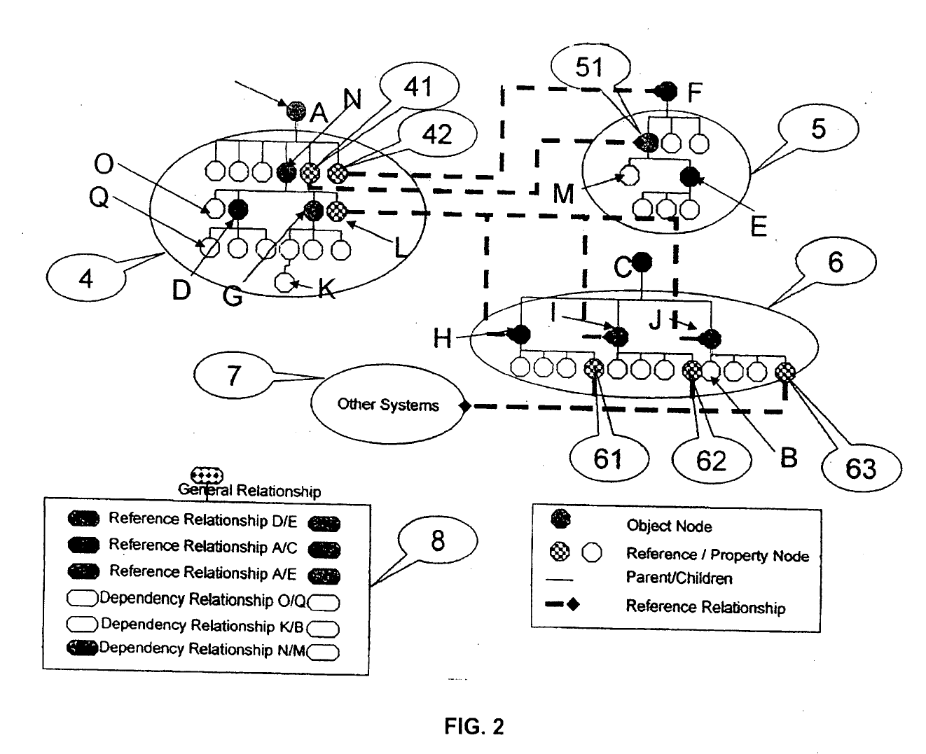

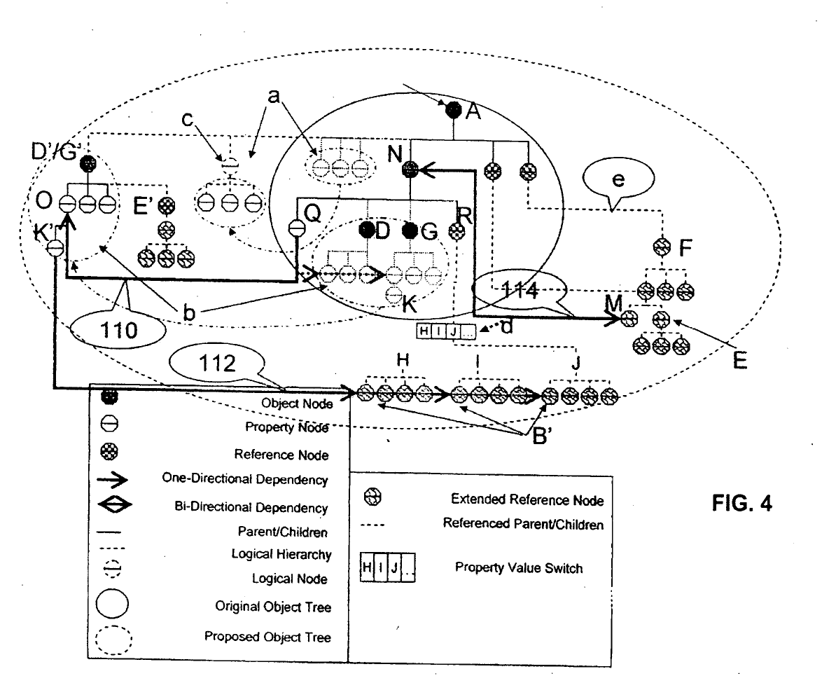

FIG. 4 shows an exemplary system view in accordance with the present invention. In FIG. 4, the three tree structures shown in FIG. 2 are assembled into one extended tree structure under a root node A by object referencing. The system may have a database which stores the relational data and a display for displaying the tree structure or the table view.

In FIG. 4, “a” indicates an operation in which the three nodes are re-allocated to the left under a new logical node M. The operation “c” indicates adding the new logical node M under the root node A. It is noted that this is only an example to show that the proposed method can arbitrary add logical nodes into the tree.

The operation “e” performs allocating the tree under the node F into the extended tree structure. The operation “b” performs re-allocating the existing nodes D and G including their children (and grand child K) into a combined tree D′/G′, the presence of K′ is based on a value switch, since D and G have a similar tree structure. It is noted that by using these node migration operations, it is possible to add a child referencing node to implement the object

[symbol]

Similar nodes can be grouped into one node to reduce redundancy during searching. As shown in FIG. 2, there are three sub-trees each including three values under multiple entries H, I and J which have a similar data structure. In FIG. 4, these three sub-trees are included into the extended tree structure by using a value switch R. It is noted that this operation is indicted by “d” in FIG. 4. By this operation, there is only one entry R with more compact view, which achieves a factor of l/n for the view. The value switch R reduces redundancy of the view and provides for fast navigation. For example, the user does not have to go through all the value nodes (in FIG. 2, through C and J, for example), but performs just one switch operation at the level of the value switch R. By using the value switch, relational structures can be converted into multiple tree hierarchies which can allow a user to start navigation from any of the objects assuming that object has a correction child node referencing to other trees.

In the conventional view shown in FIG. 2, no cross dependency allowed, thus a relationship table 8 is required. Also, the propagation needs to go through several trees, which results in redundant updating for H, I and J. This update for H, I and J is performed because current methods of relationship can not assign accurate dependency in case the relationship are between different trees. Moreover, if one of the relationship node has multiple instances that are with the same class of itself, the relationship is not able to tell which instance it really points to since all of the instances are present in that tree, for example, H,I,J are all present in the tree 6.

On the other hand, in the present invention shown in FIG. 4, the method allows for cross-dependency shown as arrows 110,112 or 114. It is noted that the arrows 110 and 112 indicate one directional dependency and the arrow 114 indicates bi-directional dependency. Updating the values may be done by monitoring the change of the property-and-value index attached to the cross dependency. The change can be accurately monitored by object-to-object cross dependency, thus no need to have extra redundant updates. For example, only J is being updated at one time.

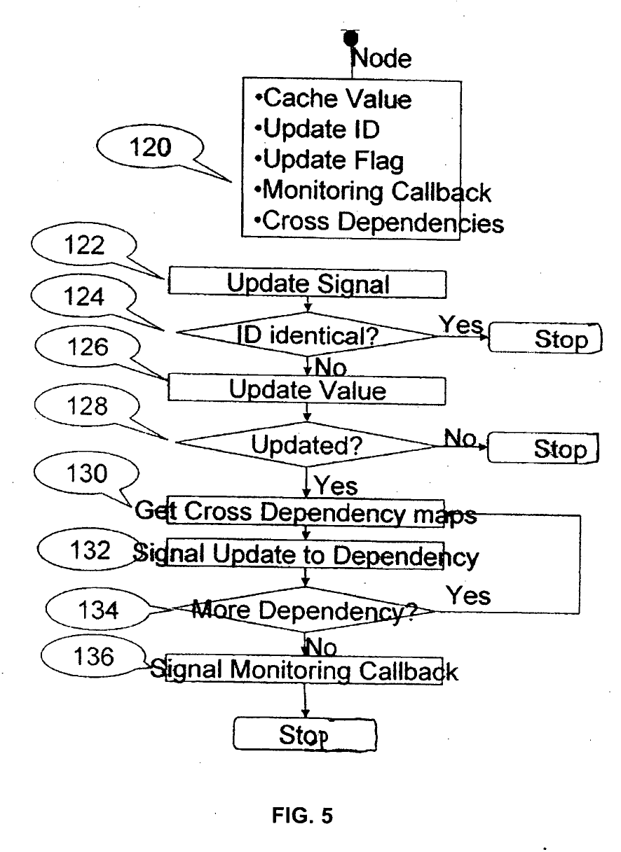

FIG. 5 shows an exemplary flow chart for monitoring the cross-dependency of the given embodiment according to the present invention. If a given node has some cross dependency relationship with other nodes, the node is provided with a cross dependency map. The cross dependency map 120 may include data such as cache value, ID, flag, callback or cross dependencies. When the system receives an update signal to the given node, the system checks the ID of the node. If the ID is not identical to the update ID its stored previously as a cached value, the system updates the property value of the node if the update signal so requests. If the property value is updated, the system obtains the cross dependency map to update the property value of the other nodes depending upon the given node. If there are two or more dependencies in the given node, updating the property value of the depending nodes will be repeated. The system may also monitor call back signals from any interested node by inserting a monitoring signal to that node. By using this monitoring scheme, user can easily monitor the change of any interested node and therefore the system can perform additional actions based on the updating signal accordingly. This also provides convenient way for use to add more monitoring scheme later after the system is built up. This invention also allows for users to plug in their own monitoring mechanism to monitor node changes.

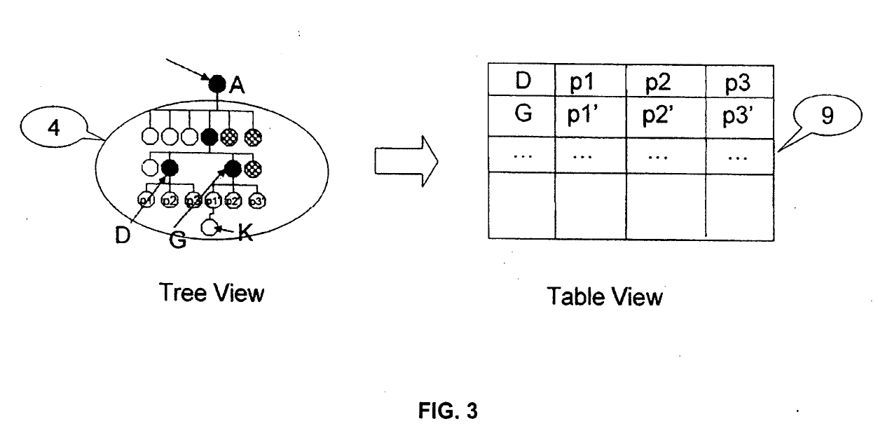

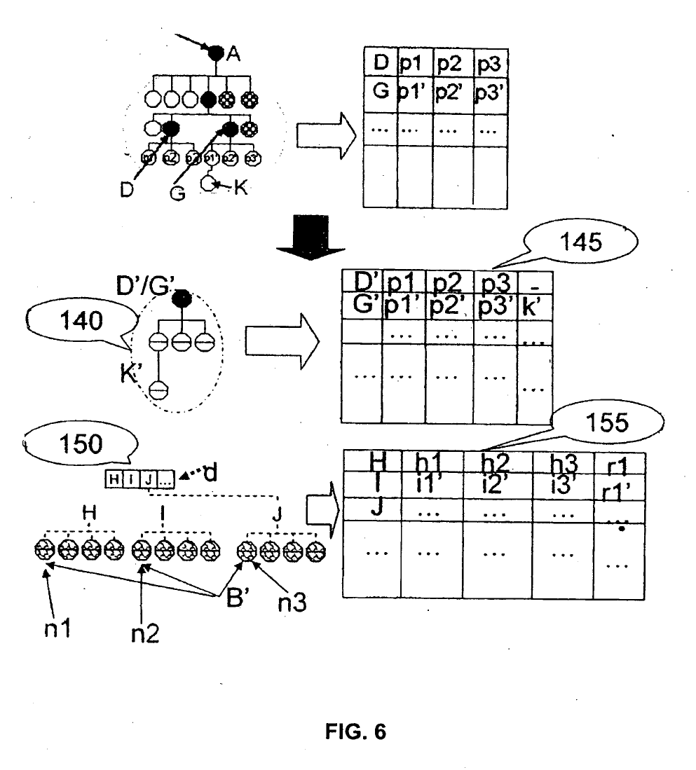

Further, FIG. 6 shows exemplary table views of the given embodiment according to the present invention. As shown in FIG. 3, in the conventional system, only current tree information can be viewed in a table where the property values of one-level can be viewed. Thus, the properties of the referenced object node cannot be included into the table view. For example, in FIG. 3, the property value of the node K can not be included in the table 9. In addition, the table implementation can not be used to deal with different node structures.

On the other hand, the system according to the present invention may extend the conventional table implementation by using the property-and-value index to generate a table view. A property-and-value view managed table allows for table content showing not only the direct children of one specific node, but also any of its arbitrary descendents. The table management was managed by the value-switch and each row represents one value inside the value switch. This also provides flexibility in displaying the content inside the table so that the table does not necessarily display all contents in the same format.

In the given embodiment the property-and-value index may be represented by using a URL. For example, when the property of node G′ is “Property1” having “value1” and the parent node of K′ has a property of “Property2” having a value of “p1′”, then a property value “k′” of node K′ can be represented as follows:

Property 1={value 1}\Property2={p1′)\k′

Thus, descendant node information can be organized into the table view with node index provided so that the table view can really be used to produce an overall view of the current node including all of the descendant nodes. For example, as shown in FIG. 6, for the nodes D′ and G′ of the modified tree 140, the table view 145 can be used. Therefore, the system and method of the present invention enable the display view to be very compact.

Further, with the extended object tree, it is possible to include referenced node and its descendants into the table view. As shown in FIG. 6, the values of the reference nodes 71,72 and 73 are included under the nodes H, I and J.

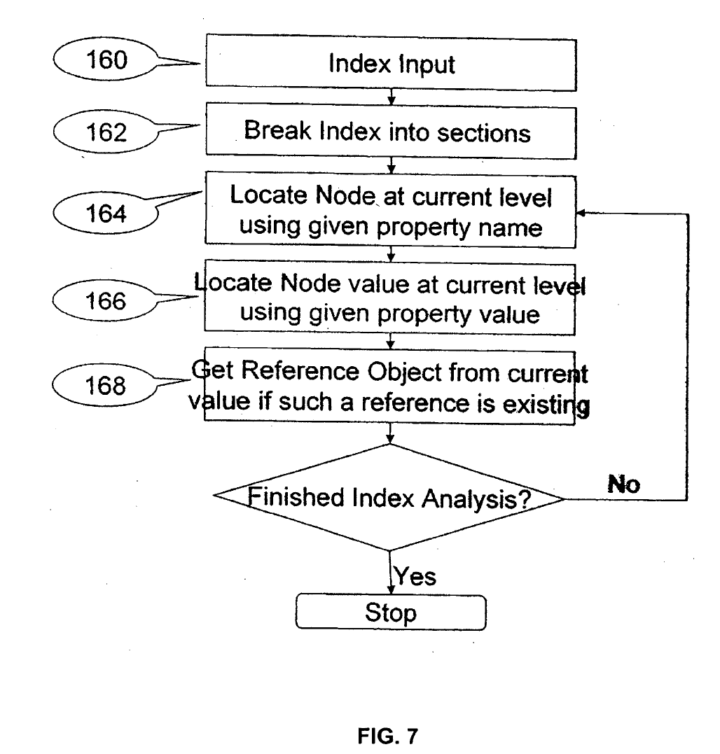

FIG. 7 shows an exemplary flow chart in an index analysis system. An index analysis system is the mapping between any property-and-value index and its real backend database. Such an index analysis extracts an action for each level and performs an action at each level if an action is required. Then, the index analysis locates the corresponding databaselmap if such a node is a real data node, and locates to the given real data, and obtains a reference to a sub-object if such a node has a reference associated by using the reference map1reference table associated with that specific value. The index analysis also performs the analysis level by level so that it can eventually arrive at its destination. Such mapping is stored into each value-switch node given that value-switch node corresponds to an existing database.

For example, the URL “Property1={value 1)\Property2={p1′)\k′” shown in FIG. 6, will trigger actions for the index analysis system as follows: break the URL into 2 sections, “Property1={value1}” and “Property2={(p1′)” (step 162 in FIG. 7); locate the node that has a URL=Property1 (step 164); go into that node and locate a value {valuel) at its associated database/mapped table (step 166); obtain a reference to that value by obtaining a reference map stored in that node or visiting a reference table associated with that node (step 168); and repeat the steps 162-168 until the URL is finally analyzed. In addition, the index analysis may convert the relative index to the absolute index with all its ancestor index information. Same logic applies to the table view creation. In the table view creation, the developer or the user can just give each column a URL to link, then the indexing system can retrieve the content based on the column and row information, where the row information comes from the value-switch and the column information comes from the URL that developer/user associated.

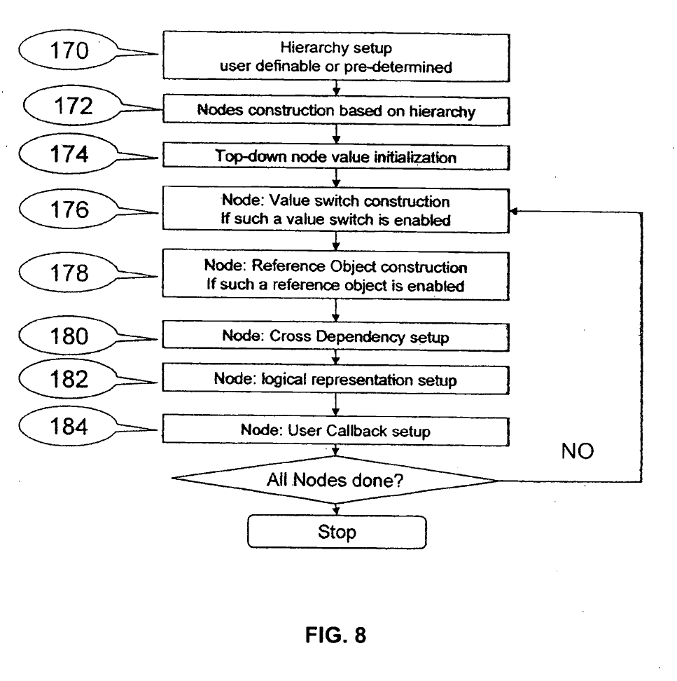

FIG. 8 shows an exemplary flow chart for implementing the method in accordance with the present invention. First, a tree structure or a hierarchy of the complex relational data, which may be stored in a database, is determined or defined by a user of the system (step 170). Next, the system assigns property, value and value index to each node of the tree structure (step 172). It is noted that the index given to the node should be relatively unique with respect to its parent and should reflect both the node's property and value information, for example the URL as described above. Also, any non-leaf nodes should contain a set of indexes indicating its visible children.

Then, the system initializes the value of each node by top-down basis (step 174). This eventually initializes each layer and therefore for each node inside the tree, it will be given an initial value, either from the database or from the default settings. User can always start from the initial values to continue on his work.

Next, the system creates value switches if such value switches are enabled (step 176). In the next step, the system assembles the trees or sub-trees into one extended tree structure under a root node by object referencing if such reference objects are enabled (step 178). Each object reference node should contain a path-based-index (i.e, same as Property-and-value index, but it can be relatively short if at some level they share with the same ancestor, then that ancestor's path can be ignored) of its reference node. It is noted that the root node may be the origin of all the absolute indexes.

The system then creates the cross dependency by referencing the reference relationship or the relationship tables (step 180). It is noted that each node stores a set of one-directional cross dependency nodes which contain a path-based-index of their related nodes. In this step, the system may set up a stop flag to prevent from falling into an infinite loop when a cross dependency loop existed.

Then, the system adds logical nodes as normal nodes (step 182). There should be information regarding which is the path-based index of the real node with respect to the logical node position. In the step of 184, the system may set up user callback. It is noted that the user

[symbol]

The system may repeat the steps of 174-184 until all nodes are manipulated. It is noted that the order of the steps of 174-184 may vary.

It is further noted that the system or method of the present invention can be implemented by a computer or workstation by using software.

Other feasible techniques could be implemented to monitor the dependency watching mechanism such as message loop, signal/slot and etc. Table view is implemented with the table corresponding to a set of indexes to be displayed into the current table, and the table view would locate all the nodes common ancestors and starting from that node to perform population.

### Application 1

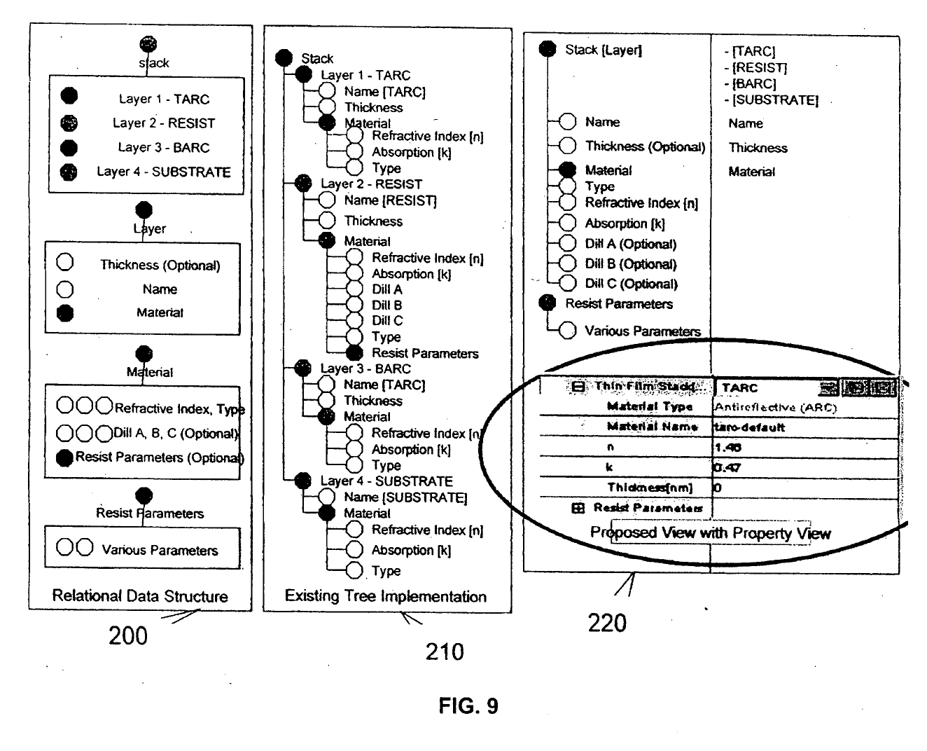

The system or method in accordance with the present invention may be applied to a lithography simulation systems which employ many complex optical and material parameters. FIG. 9 shows an exemplary application to the lithography simulation system (e.g. LithoCruiser from ASML Masktools of Santa Clara, Calif.). The left column 200 shows a data structure of the lithography system in the conventional manner. The center column 210 shows tree implementation in the conventional manner. For example, the node “stack” has four child nodes having property “layer N”. Each “layer N” has “name”, “thickness” and “material’ as properties, and “material” further includes other properties such as “refractive index” or “absorption”. The property value of “refractive index” of “material ARC” of “layer 1” may be 1.46. It is noted that the material properties under Layer 2 (RESIST) are different from the others.

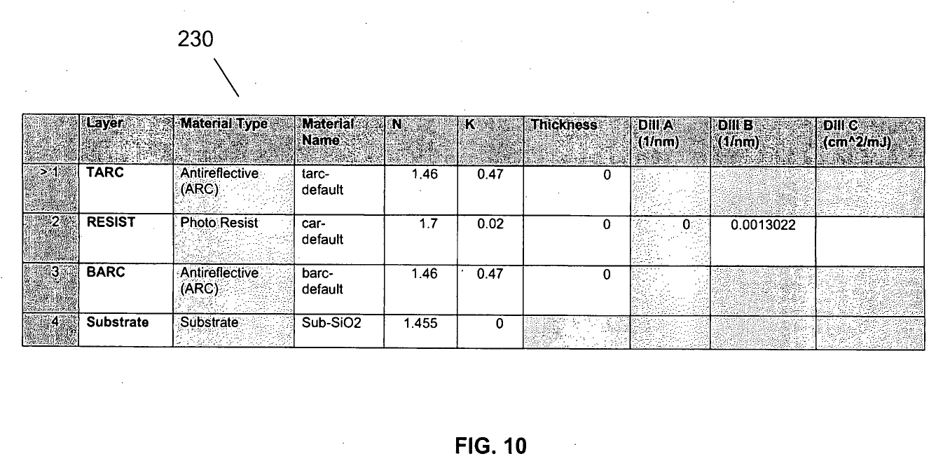

By using the system or method of the present invention, the conventional tree implementation 210 is converted into the new tree structure 220. It is noted that the material properties are re-organized so that the tree view becomes more compact. The system created value switches such as [TARC], [RESIST], [BARC] and [SUBSTRATE] for the “Layer” property name, which enables the table view 230 to be more compact as shown in FIG. 10. In this table view, each row has different properties because of the re-organization of nodes (i.e. RESIST, TARC, Substrate are different). For example, only the row (2) for RESIST contains “Dill” parameters as properties and the row for SUBSTRATE does not contain the property of thickness.

### Application 2

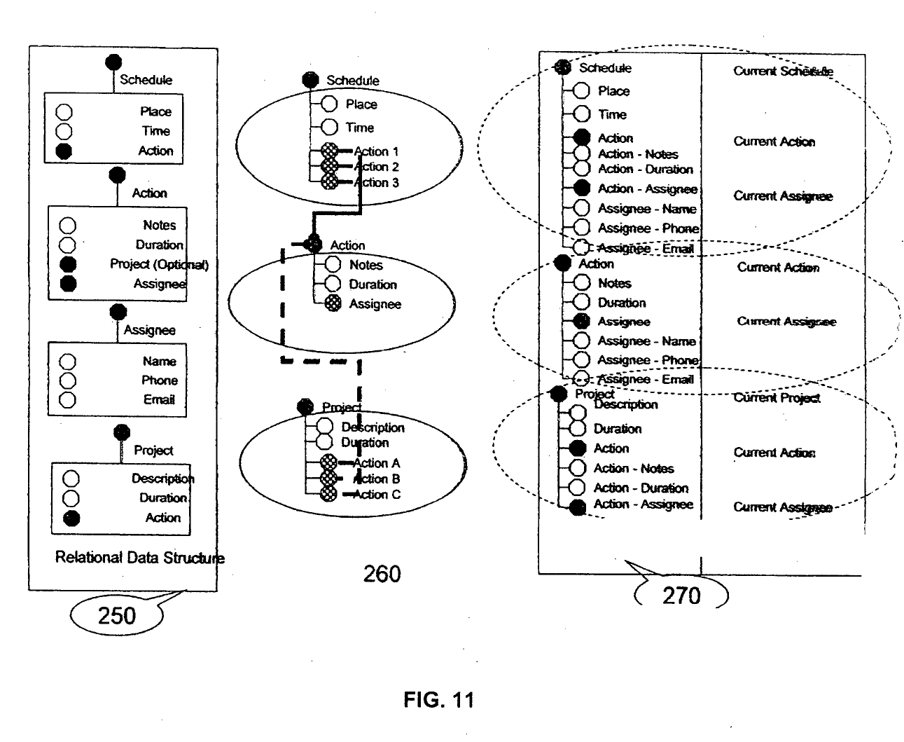

The system and method of the present invention may also be applied to a portable device display. FIG. 11 shows an exemplary application to the portable device display (e.g. notebook or tablet PC, PDA, cell phone, etc.). The left column 250 shows a date structure of the portable device display in the conventional manner. The center column 260 shows tree implementation in the conventional manner. It is noted that there are reference relationships among “Actions” and three different data entries (“Schedule”, “Action” and “Project”),

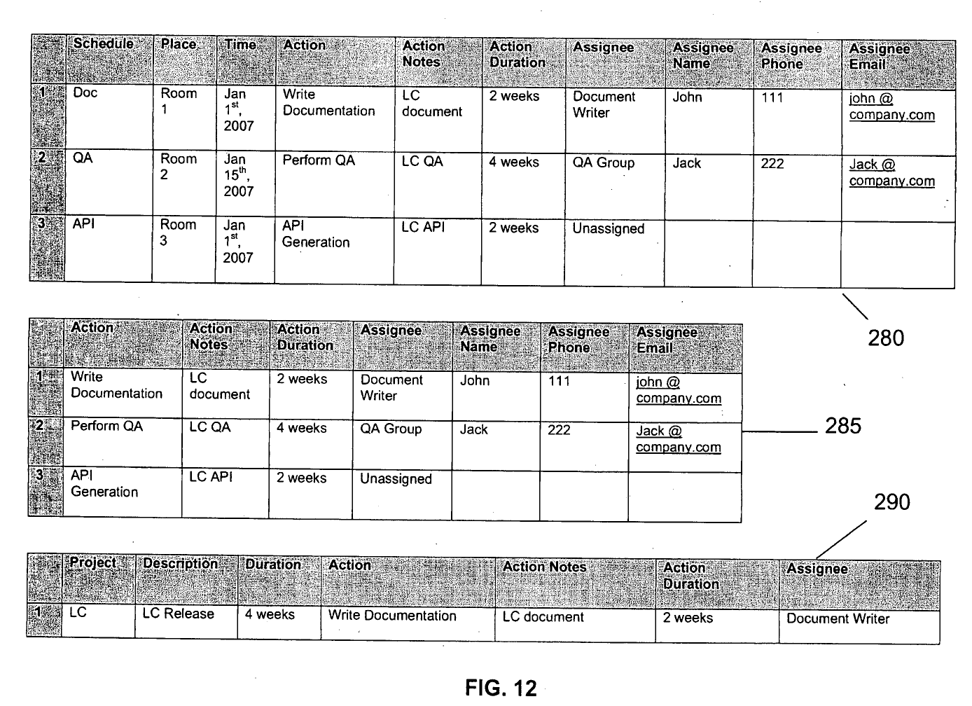

As shown in the right column 270 of FIG. 11, the application of the system and method of the present invention allows multiple entries and each entry can be enabled to navigate through all the nodes. The application demonstrates the ability of the method to generate an extended virtual tree for any entry. Users can start from schedule, action, or project to navigate. The invention enables reorganization of the topology of the tree structure for a more logical display as required by user when necessary. In addition, as shown in FIG. 12, the application of the present invention enables compact views for a schedule table 280, an action table 285 or a project table 290. It is noted that tree 270 doesn't have a real root node since the purpose for tree 270 is to provide multiple entry-points for user to navigate. However, in the system implementation, a logical root node is created to contain all these three trees, but it is now shown in the picture since it is only virtual root.

One of the advantages associated with the present invention is that it provides easy navigation through the nodes. It also provides referencing for non-leaf node. Yet another advantage is that it provides easy and efficient updating of cross dependency among the nodes. It further enables the reduction of redundancy and improved flexibility. The present invention also provides an improved table view with overall view and flexibility.

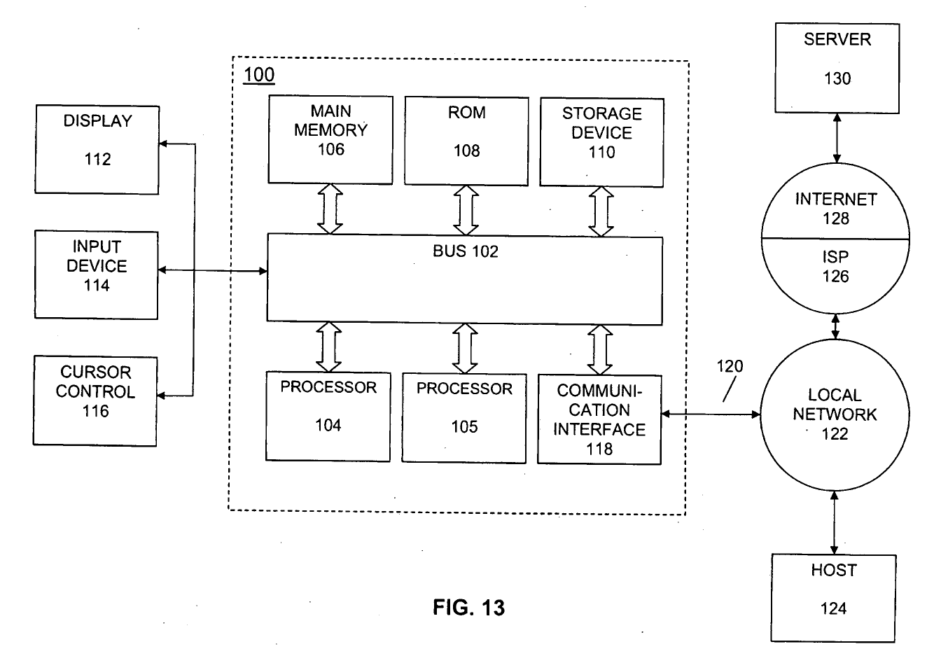

FIG. 13 is a block diagram that illustrates a computer system 100 which can utilize the data management/display process explained above. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 fbrther includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or flat panel or touch panel display for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A touch panel (screen) display may also be used as an input device.

According to one embodiment of the invention, the mask design process may be aided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also preferably includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the invention, one such downloaded application provides for the illumination optimization of the embodiment, for example. The received code may be executed by processor 104 as it is received, and/or stored in storage device 110, or other non-volatile storage for later execution. In this manner, computer system 100 may obtain application code in the form of a carrier wave.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method of managing data with a relational data structure, wherein the data is organized as one or more tree structures having sub-tree structures, each tree or sub-tree structure comprising nodes, and relationship information indicating a relationship between the nodes, the method comprising:
allocating at least one of the tree structures or the sub-tree structures into another tree structure according to the relationship information, if the relationship information indicates that a node in the at least one of the tree structures or the sub-tree structures relates to one or more of the nodes of the another tree structure.

2. The method of claim 1, further comprising reallocating a sub-tree structure within a tree structure to which the sub-tree structure belongs.

3. The method of claim 2, wherein the reallocating includes adding a node between the sub-tree structure and the tree structure.

4. The method of claim 1, wherein the allocating includes adding a value switch between the one of the tree structures or the sub-tree structures and the another tree structure, wherein the value switch is configured to select a node of the one of the tree structures or the sub-tree structures.

5. The method of claim 1, further comprising adding cross dependency information to a node indicating dependency between the nodes.

6. The method of claim 1, wherein the nodes comprise property and value, the method further comprising creating a table view displaying the property and value of the nodes.

7. The method of claim 6, wherein the table view includes property and value of a descendant node.

8. A system for managing data with a relational data structure, wherein the data is organized as one or more tree structures having sub-tree structures, each tree or sub-tree structure comprising nodes, and relationship information indicating a relationship between the nodes, the system comprising:
a database for storing the relational data structure; and
an allocating section configured to allocate at least one of the tree structures or the subtree structures into another tree structure according to the relationship information, if the relationship information indicates that a node in the at least one of the tree structures or the subtree structures relates to one or more of the nodes of the another tree structure.

9. The system of claim 8, wherein the allocating section is further configured to reallocate a sub-tree structure within a tree structure to which the sub-tree structure belongs.

10. The system of claim 9, wherein the allocating section is further configured to add a node between the sub-tree structure and the tree structure.

11. The system of claim 8, wherein the allocating section is further configured to add a value switch between the one of the tree structures or the sub-tree structures and the another tree structure, wherein the value switch is configured to select a node of the one of the tree structures or the sub-tree structures.

12. The system of claim 8, further comprising an adding section configured to add cross dependency information to a node indicating dependency between the nodes.

13. The system of claim 8, wherein the nodes comprise property and value, the system further comprising:
a table creating section configured to create a table view displaying the property and value of the nodes.

14. The system of claim 13, wherein the table view includes property and value of a descendant node.

15. A lithography simulation system, comprising the system for managing data with a relational data structure of claim 8.

16. A portable device, comprising the system for managing data with a relational data structure of claim 8.

17. A computer readable medium having stored therein a set of instructions, which when executed by a computer, perform the method of claim 1.
